(19) United States
(12) Patent Application Publication
(10) Pub. No.: US 2018/0137752 A1
(43) Pub. Date: May 17, 2018

(54) TRAFFIC MONITORING SYSTEM CAPABLE OF REPORTING THE TRAFFIC CONDITION IN REAL TIME

(71) Applicants: Inventec (Pudong) Technology Corp., Shanghai (CN); Inventec Corporation, Taipei (TW)

(72) Inventor: Tsung-Hsi Lee, Taipei (TW)

(21) Appl. No.: 15/465,554

(22) Filed: Mar. 21, 2017

(30) Foreign Application Priority Data
Nov. 16, 2016 (CN) 201611021775.2

(51) Int. Cl. G08G 1/01; G08G 1/052; H04W 4/04

(52) U.S. Cl. CPC G08G 1/0141; G08G 1/0112; H04W 4/046; G08G 1/052; G08G 1/0133

(57) ABSTRACT

A Traffic monitoring system includes a plurality of mobile report devices and a central control server. The mobile report devices communicate with the wireless communication base stations nearby to get the real-time locations of the mobile report devices. The central control server communicates with the mobile report devices periodically to get the real-time locations of the mobile report devices, and generates the speeds of the mobile report devices according to real-time locations of the mobile report devices derived at different time points. The central control server identifies the road sections where the mobile report devices are located according to the real-time locations of the mobile report devices, and determines a traffic condition according to the speeds of the mobile report devices and the maximum speed limits of the road sections.

### BACKGROUND OF THE INVENTION

### 1. Field of the Invention

The present invention relates to a traffic monitoring system, especially to a traffic monitoring system capable of reporting the traffic condition in real time.

### 2. Description of the Prior Art

Since more and more people rely on vehicles for transportation, traffic condition has become difficult to predict. The drivers may listen to the radio broadcast to learn about traffic information to avoid traffic jams. However, traffic information is usually provided by drivers and passengers on the street, so most of the information is about places near busy roads and may not be helpful to all drivers. In addition, after the driver or passenger provides the traffic information, the information provider hardly updates the traffic information, making the traffic condition still unpredictable and causing inconvenience to the drivers.

To provide the traffic information in real time, prior art has proposed applications on cell phones for monitoring the traffic condition. However, most of the applications derive the traffic information through the web cameras on the roads. Since the web cameras require considerable cost and have difficulty of being installed on every street, the applications may only derive the information from the web cameras installed on the main streets, such as highways. However, even if the driver learns about the traffic jams on certain streets, the driver is still not able to find out an alternative route with less traffic by using the application. Thus the drivers can only try to avoid the rush hour to avoid heavy traffic.

### SUMMARY OF THE INVENTION

One embodiment of the present invention discloses a traffic monitoring system. The traffic monitoring system includes a plurality of mobile report devices and a control server.

The mobile report devices communicate with wireless communication base stations nearby to get real-time locations of the mobile report devices. The control server communicates with the mobile report devices periodically to get the real-time locations of the mobile report devices, generates speeds of the mobile report devices according to real-time locations of the mobile report devices derived at different time points, identifies road sections where the mobile report devices are located according to the real-time locations of the mobile report devices, and determines traffic conditions of the road sections according to at least the speeds of the mobile report devices and maximum speed limits of the road sections.

Another embodiment of the present invention discloses a method for operating a traffic monitoring system. The traffic monitoring system includes a plurality of mobile report devices and a control server. The method includes the mobile report devices communicating with wireless communication base stations nearby to report real-time locations of the mobile report devices, the control server communicating with the mobile report devices periodically to get the real-time locations of the mobile report devices, the control server generating speeds of the mobile report devices according to real-time locations of the mobile report devices derived at different time points, the control server identifying road sections where the mobile report devices are located according to the real-time locations of the mobile report devices, and the control server determining traffic conditions of the road sections according to at least the speeds of the mobile report devices and maximum speed limits of the road sections.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a traffic monitoring system according to one embodiment of the present invention.

FIG. 2 shows a method for operating the traffic monitoring system in FIG. 1.

### DETAILED DESCRIPTION

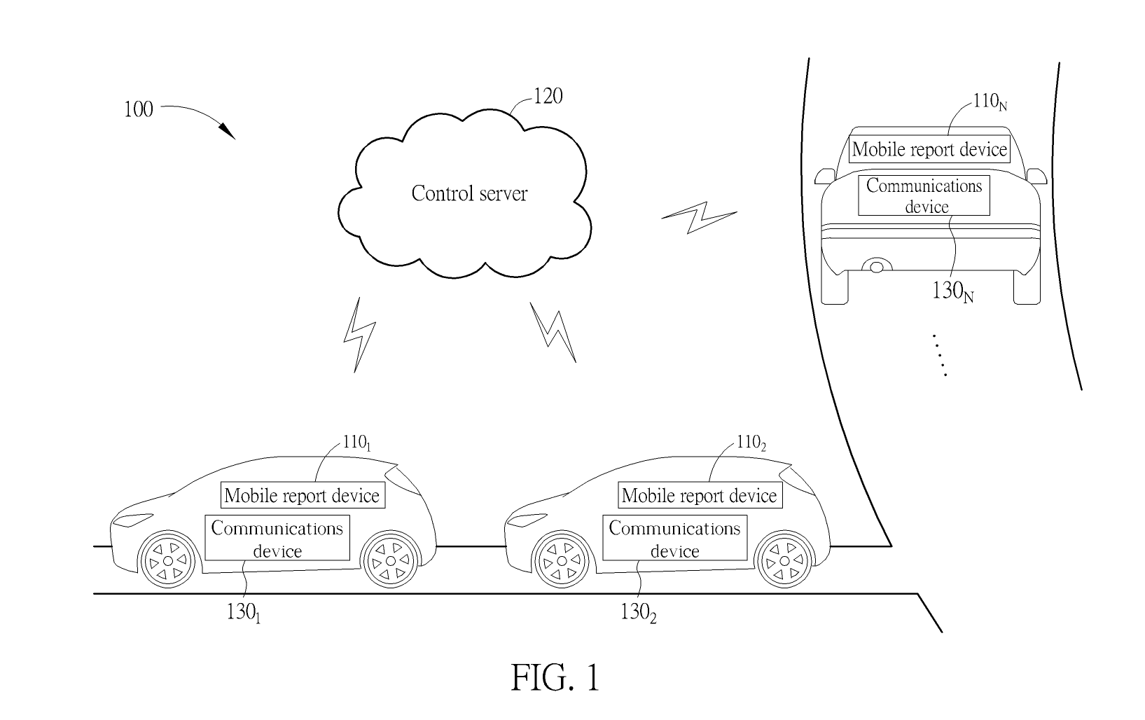

FIG. 1 shows a traffic monitoring system 100 according to one embodiment of the present invention. The traffic monitoring system 100 includes a plurality of mobile report devices 110₁ to 110_{N} and a control server 120.

The mobile report devices 110₁ to 110_{N} can communicate with the wireless communication base stations nearby to get the real-time locations of the mobile report devices 110₁ to 110_{N}. For example, the wireless communication base stations maybe of the 3^{rd} generation (3G), the 4^{th} generation (4G), or Wi-Fi. Since the mechanism for deriving and recording the locations of the wireless communication base stations, such as the longitude and latitude positions, has been developed, the mobile report devices 110₁ to 110_{N} can derive their real-time locations according to the locations of the wireless communication base stations during the communications with the wireless communication base stations nearby.

The control server 120 can communicate with the mobile report devices 110₁ to 110_{N} periodically to get the real-time locations of the mobile report devices 110₁ to 110_{N}, and can generate the speeds of the mobile report devices 110₁ to 110_{N} according to real-time locations of the mobile report devices 110₁ to 110_{N} derived at different time points. For example, if the real-time coordinates of the mobile report device 110₁ received by the control server 120 initially are (X1,Y1), and the real-time coordinates of the mobile report device 110₁ received by the control server 120 ten seconds later are (X2,Y2), then the control server 120 can calculate the distance between the real-time coordinates (X1,Y1) received initially and the real-time coordinates (X2, Y2) received ten seconds later and divide the distance by the time interval, 10 seconds, to calculate the speed of the mobile report device 110₁. In some embodiments of the present invention, the real-time coordinates (X1,Y1) and (X2, Y2) can be the longitude and latitude coordinates used by the Global Positioning System (GPS).

The mobile report devices 110₁ to 110_{N} can be electronic devices that can access the internet, such as smart phones and tablet. The users can activate the corresponding application on the electronic device and use the electronic device as the mobile report device to report its real-time location to the control server 120. In this case, to ensure the real-time locations reported by the mobile report devices 110₁ to 110_{N} can represent the locations of the vehicles, the traffic monitoring system 100 may further include a plurality of communications devices 130₁ to 130_{N}, the communications devices 130₁ to 130_{N} are disposed in the vehicles, and each can be the micro-computer of the vehicle, for example.

The communications devices 130₁ to 130_{N} can establish connections, such as Bluetooth or Wi-Fi connections, with the mobile report devices 110₁ to 110_{N} disposed in the same vehicles. By identifying whether the connections between the communications devices 130₁ to 130_{N} and the mobile report devices 110₁ to 110_{N} have been established or not, the control server 120 can determine whether the mobile report devices 110₁ to 110_{N} have been disposed in the vehicles for reporting the locations of the vehicles or not.

For example, the control server 120 can start to communicate with the mobile report device 110₁ periodically to get the real-time location of the mobile report device 110₁ after the connection between the mobile report device 110₁ and the communications device 130₁ is established.

In addition, the control server 120 may look up the map with the real-time locations of the mobile report devices 110₁ to 110_{N} to identify the road sections where the mobile report devices 110₁ to 110_{N} are located, and determine the traffic conditions of the road sections according to the speeds of the mobile report devices 110₁ to 110_{N} and the maximum speed limits of the road sections.

For example, the control server 120 may compare the real time coordinates (X1,Y1) of the mobile report device 110₁ with the map, and identify that the coordinates (X1,Y1) are near No. 100 to No. 130, the first avenue. Therefore, the control server 120 may identify the road section where the mobile report device 110₁ is located is No. 100 to No. 130, the first avenue.

Generally, 3G or 4G base stations have larger communications coverage, therefore if the mobile report device 110₁ uses 3G or 4G base stations to derive its real-time location, the real-time location would be less accurate. In contrast, Wi-Fi base stations have smaller communications coverage, therefore Wi-Fi base stations may be set up in a greater density, and the real-time location of the mobile report device 110₁ would be more accurate if Wi-Fi base stations are used to derive the real-time location.

To prevent the control server 120 from misidentifying the road sections where the mobile report device 110₁ is located, in some embodiments, when the control server 120 determines the road sections, the control server 120 may ask the mobile report device 110₁ to derive its real-time location through Wi-Fi base stations rather than 3G or 4G base stations, when available, if the mobile report device 110₁ seems to be located on a secondary road in a suburban area since the data in the suburban area may be relatively insufficient and the tolerance for inaccuracy is relatively small. However, if the mobile report device 110₁ seems to be located on a main street in a city area, then the control server 120 can allow the mobile report device 110₁ to derive its real-time location through Wi-Fi base stations, 3G base stations or 4G base stations without preference since the data in the city area may be relatively sufficient and the tolerance for inaccuracy is relatively big.

After deriving the real-time location of the mobile report device 110₁ and identifying the located road section to be No. 100 to No. 130, the first avenue, the control server 120 may look up for the maximum speed limit along No. 100 to No. 130, the first avenue, and compare the maximum speed limit with the speed of the mobile report device 110₁. To report the traffic condition even more accurately, the control server 120 may also consider the speeds of other mobile report devices near No. 100 to No. 130, the first avenue.

In some embodiments, when the average speed or median speed of the mobile report devices on a specific road section is greater than the first predetermined percentage of the maximum speed limit of the specific road section, the control server 120 may identify the traffic condition of the specific road section as light. For example, if the mobile report devices 110₁ to 110_{N} are near No. 100 to No. 130, the first avenue, the maximum speed limit near No. 100 to No. 130, the first avenue is 50 km/hr., the first predetermined percentage is 80 percent, and the average or median speed of the mobile report devices 110₁ to 110_{N} is over 40 km/hr., meaning most of the mobile report devices 110₁ to 110_{N} are moving with speeds near the maximum speed limit, then the control server 120 may identify the traffic condition near No. 100 to No. 130, the first avenue to be light.

In contrast, when the average or median speed of the mobile report devices on a specific road section is smaller than the second predetermined percentage of the maximum speed limit of the specific road section, the control server 120 may identify the traffic condition of the specific road section as heavy. For example, if the maximum speed limit near No. 100 to No. 130, the first avenue is 50 km/hr., the second predetermined percentage is 40 percent, and the average or median speed of the mobile report devices 110₁ to 110_{N} is less than 20 km/hr., meaning most of the mobile report devices 110₁ to 110_{N} are moving with speeds lower than half of the maximum speed limit, then the control server 120 may identify the traffic condition near No. 100 to No. 130, the first avenue to be heavy. If the average or median speed of the mobile report devices 110₁ to 110_{N} is between the first percentage of the maximum speed limit and the second percentage of the maximum speed limit, then the control server 120 may identify the traffic condition as moderate.

In some embodiments, the control server 120 can present the identified traffic condition on the map for user's reference. For example, the corresponding road sections on the map can be marked with different colors to show different conditions. For example, green means light, orange means moderate, and red means heavy.

In addition to identifying the traffic condition of the road section by the average or median speed of the mobile report devices near the road section, the control server can further exclude some of the mobile report devices having extremely high speeds and extremely low speeds, avoiding individual drivers not driving properly to affect the identification of traffic condition.

Moreover, in some embodiments, the control server 120 can calculate the vehicle density of a road section according to the number of mobile report devices on the same road section, and identify the traffic condition of the road section according to the speeds of the mobile report devices, the maximum speed limits of the road section, and the vehicle density of the road section.

In other words, when the control server 120 derive the speed of the mobile report device 110₁ as 10 km/hr., which is 20% of the maximum speed of the road section where the mobile report device 110₁ is located, the control server 120 can further check the vehicle density of the same road section. If the vehicle density is quite low, then the mobile report device 110₁ may be a special case. For example, the mobile report device 110₁ may be just pulling over and waiting for the red light. In this case, after the overall analysis, the control server 120 may still identify the traffic condition to be light.

In practice, chances are that not all the drivers are using the traffic monitoring system 100, so the control serve 120 may not only consider the number of mobile report devices on a road section when calculating the vehicle density but consider also the percentage of drivers that uses the monitoring system among all drivers, making the calculated vehicle density more close to reality.

In addition, in some embodiments of the present invention, the communications devices 130₁ to 130_{N} may be able to get the information related to the vehicles themselves, such as the level of fuel contained, and the speed of the vehicle. In this case, the communications devices 130₁ to 130_{N} may also report the speeds of the vehicles to the mobile report devices 110₁ to 110_{N}, and the mobile report devices 110₁ to 110_{N} can upload the speeds of the vehicles to the control server 120 for reference. Therefore, the control server 120 may use the speeds reported by the mobile report devices 110₁ to 110_{N} and the maximum speed limits of the road sections to identify the traffic conditions.

Since the traffic monitoring system 100 can retrieve the location information of the mobile report devices 110₁ to 110_{N} all around and calculate the speeds of the mobile report devices 110₁ to 110_{N} to identify the condition of traffic flow on the road sections where the mobile report devices 110₁ to 110_{N} are located, the traffic monitoring system 100 is able to provide the traffic conditions all over the country for the users in real time. In addition, since the user may use his/her mobile electronic device as the mobile report device, the traffic monitoring system 100 does not need additional web cameras or other hardware equipment.

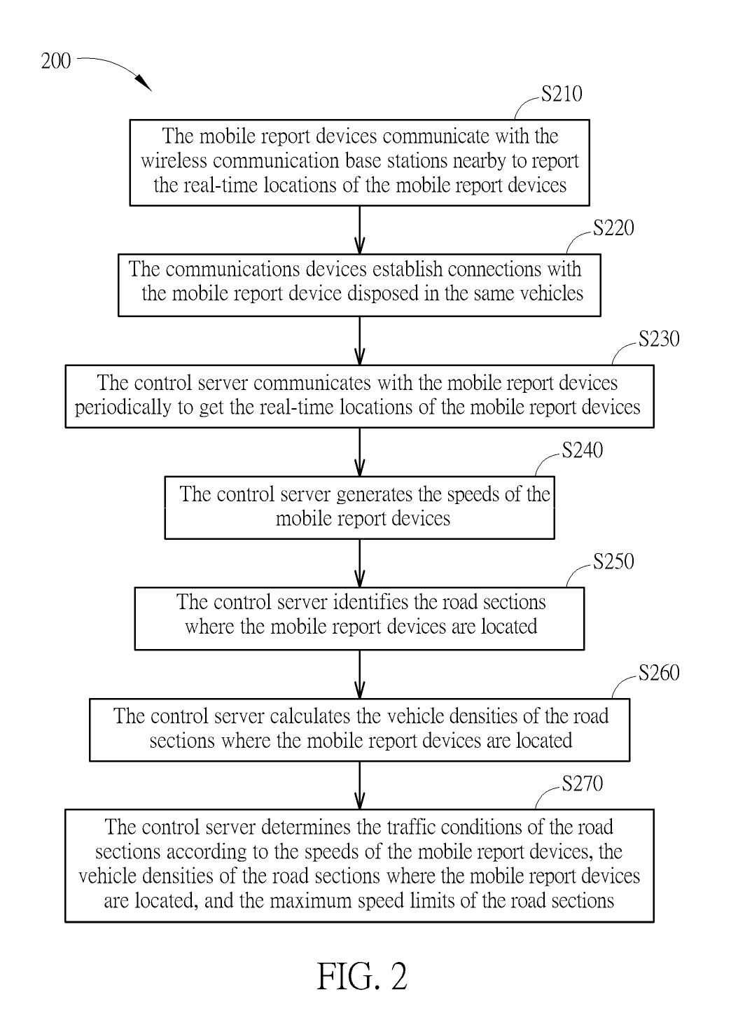

FIG. 2 shows a method 200 for operating the traffic monitoring system 100. The method 200 includes but is not limited to steps S210 to S270.
S210: the mobile report devices 110₁ to 110_{N} communicate with the wireless communication base stations nearby to report the real-time locations of the mobile report devices 110₁ to 110_{N};
S220: the communications devices 130₁ to 130_{N} establish connections with the mobile report device 110₁ to 110_{N} disposed in the same vehicles;
S230: the control server 120 communicates with the mobile report devices 110₁ to 110_{N} periodically to get the real-time locations of the mobile report devices 110₁ to 110_{N};
S240: the control server 120 generates the speeds of the mobile report devices 110₁ to 110_{N} according to real-time locations of the mobile report devices 110₁ to 110_{N} derived at different time points;
S250: the control server 120 identifies the road sections where the mobile report devices 110₁ to 110_{N} are located according to the real-time locations of the mobile report devices 110₁ to 110_{N};
S260: the control server 120 calculates the vehicle densities of the road sections where the mobile report devices 110₁ to 110_{N} are located;
S270: the control server 120 determines the traffic conditions of the road sections according to the speeds of the mobile report devices 110₁ to 110_{N}, the vehicle densities of the road sections where the mobile report devices 110₁ to 110_{N} are located, and the maximum speed limits of the road sections.

In FIG. 2, the communications devices 130₁ to 130_{N} can establish connections with the mobile report device 110₁ to 110_{N} disposed in the same vehicles in step S220, and the control server 120 will perform the step S230 to get the real-time locations of the mobile report devices 110₁ to 110_{N} afterward. That is, after the communications devices 130₁ to 130_{N} establish connections with the mobile report devices 110₁ to 110_{N}, the control server 120 can confirm that the mobile report devices 110₁ to 110_{N} are disposed in the vehicles so the real-time locations of the mobile report devices 110₁ to 110_{N} can be deemed as the real-time locations of the vehicles without misidentification. However, in some embodiments, step S220 can be skipped. For example, if the vehicle does not contain any devices that can establish connection with the mobile report device, then the method 200 may skip step S220.

After deriving the speeds of the mobile report devices 110₁ to 110_{N}, the vehicle densities of the road sections where the mobile report devices 110₁ to 110_{N} are located, and the maximum speed limits of the road sections, the control server 120 can perform step S270 to identify traffic conditions of the road sections. For example, when the average or median speed of the mobile report devices in a specific road section is greater than the first predetermined percentage of the maximum speed limit of the specific road section, the control server 120 can identify the traffic condition of the specific road section as light. When the average or median speed of the mobile report devices in the specific road section is smaller than the second predetermined percentage of the maximum speed limit of the specific road section, the control server 120 can identify the traffic condition of the specific road section as heavy.

In addition, in some embodiments, the communications devices 130₁ to 130_{N} may be able to get the information related to the vehicles themselves, such as the level of fuel contained, and the speed of the vehicle. In this case, the communications devices 130₁ to 130_{N} may also report the speeds of the vehicles to the mobile report devices 110₁ to 110_{N}, and the mobile report devices 110₁ to 110_{N} can upload the speeds of the vehicles to the control server 120 for reference. Therefore, the control server 120 may use the speeds reported by the mobile report devices 110₁ to 110_{N} and the maximum speed limits of the road sections to identify the traffic conditions.

In summary, the traffic monitoring system and the method for operating the traffic monitoring system provided by the embodiments of the present invention can retrieve the location information of the mobile report devices all around and calculate the speeds of the mobile report devices to identify the condition of the traffic flow on the road sections where the mobile report devices are located. Therefore, the thorough traffic conditions all over the country can be provided for the users in real time. In addition, since the user may use his/her mobile electronic device as the mobile report device, the traffic monitoring system and the method for operating the traffic monitoring system does not need additional web cameras or other hardware equipment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A traffic monitoring system, comprising:
a plurality of mobile report devices configured to communicate with wireless communication base stations nearby to get real-time locations of the mobile report devices; and
a control server configured to communicate with the mobile report devices periodically to get the real-time locations of the mobile report devices, generate speeds of the mobile report devices according to real-time locations of the mobile report devices derived at different time points, identify road sections where the mobile report devices are located according to the real-time locations of the mobile report devices, and determine traffic conditions of the road sections according to at least the speeds of the mobile report devices and maximum speed limits of the road sections.

2. The traffic monitoring system of claim 1, further comprising a plurality of communications devices each disposed in a vehicle and configured to establish a connection with a mobile report device disposed in the vehicle, wherein the control server starts to communicate with the mobile report device in the vehicle periodically to get a real-time location of the mobile report device after the connection between the mobile report device and the communications device is built.

3. The traffic monitoring system of claim 2, wherein:
the communications device is further configured to transmit a speed of the vehicle to the mobile report device;
the mobile report device is further configured to transmit the speed to the control server; and
the control server identifies the traffic conditions of the road sections according to at least the speeds of the mobile report devices, the speed, and the maximum speed limits of the road sections.

4. The traffic monitoring system of claim 1, wherein:
when an average or median speed of a plurality of mobile report devices in a specific road section is greater than a first predetermined percentage of a maximum speed limit of the specific road section, the control server identifies the traffic condition of the specific road section as light;
when the average or median speed of the plurality of mobile report devices in the specific road section is smaller than a second predetermined percentage of the maximum speed limit of the specific road section, the control server identifies the traffic condition of the specific road section as heavy; and
the first predetermined percentage is greater than the second predetermined percentage.

5. The traffic monitoring system of claim 1, wherein the control server is further configured to calculate vehicle densities of the road sections, and the control server identifies the traffic conditions of the road sections according to at least the speeds of the mobile report devices, the maximum speed limits of the road sections, and the vehicle densities of the road sections.

6. A method for operating a traffic monitoring system, the traffic monitoring system comprising a plurality of mobile report devices and a control server, the method comprising:
the mobile report devices communicating with wireless communication base stations nearby to report real-time locations of the mobile report devices;
the control server communicating with the mobile report devices periodically to get the real-time locations of the mobile report devices;
the control server generating speeds of the mobile report devices according to real-time locations of the mobile report devices derived at different time points;
the control server identifying road sections where the mobile report devices are located according to the real-time locations of the mobile report devices; and
the control server determining traffic conditions of the road sections according to at least the speeds of the mobile report devices and maximum speed limits of the road sections.

7. The method of claim 6, wherein the traffic monitoring system further comprises a plurality of communications devices each disposed in a vehicle, and the method further comprises:
the communications device establishing a connection with a mobile report device disposed in the vehicle before the control server communicates with the mobile report devices periodically to get the real-time locations of the mobile report devices.

8. The method of claim 7, further comprising:
the communications device transmitting a speed of the vehicle to the mobile report device; and
the mobile report device transmitting the speed to the control server;
wherein the control server identifying the traffic conditions of the road sections according to at least the speeds of the mobile report devices and maximum speed limits of the road sections is the control server identifying the traffic conditions of the road sections according to at least the speeds of the mobile report devices, the speed, and the maximum speed limits of the road sections.

9. The method of claim 6, wherein:
when an average or median speed of a plurality of mobile report devices in a specific road section is greater than a first predetermined percentage of a maximum speed limit of the specific road section, the control server identifies the traffic condition of the specific road section as light;
when the average or median speed of the plurality of mobile report devices in the specific road section is smaller than a second predetermined percentage of the maximum speed limit of the specific road section, the control server identifies the traffic condition of the specific road section as heavy; and
the first predetermined percentage is greater than the second predetermined percentage.

10. The method of claim 6, further comprising the control server calculating vehicle densities of the road sections, wherein the control server identifying the traffic conditions of the road sections according to at least the speeds of the mobile report devices and maximum speed limits of the road sections is the control server identifying the traffic conditions of the road sections according to at least the speeds of the mobile report devices, the maximum speed limits of the road sections, and the vehicle densities of the road sections.
